(19) United States
(12) Patent Application Publication
(10) Pub. No.: US 2017/0007015 A1
(43) Pub. Date: Jan. 12, 2017

(54) BRUSH DRYING DEVICE

(71) Applicant: Luft Industrie Inc., Oakland, CA (US)

(72) Inventor: Oliver Albers, Oakland, CA (US)

(21) Appl. No.: 14/796,594

(22) Filed: Jul. 10, 2015

(51) Int. Cl. A46B 17/08; F26B 5/14

(52) U.S. Cl. CPC A46B 17/08; F26B 5/14

(57) ABSTRACT

Provided is a brush drying device including a strap having a head portion, a tail portion, and an elongate body portion between the head portion and the tail portion. The head portion includes a slot having a width and a height sized to receive the tail portion there through to form a loop between the head portion and the tail portion with at least the body portion. The further the tail portion is pulled through the slot, the smaller a circumference of the loop becomes, such that, when the loop is placed around bristles of a brush and the tail portion is pulled further through the slot, the decreasing circumference of the loop causes the body portion of the strap to compress the bristles and wring moisture therefrom.

### FIELD

The present inventive concept relates generally to a device for drying a brush and, more specifically, to a strap used to compress the bristles of a brush to wring moisture therefrom.

### BACKGROUND

With proper care, various types of soft bristle brushes can be used for long periods of time. Proper care not only includes proper use and storage, but also proper cleaning and drying of the bristles. Drying after use or cleaning is important, since leaving the bristles wet can lead to deterioration of the bristles and/or brush handle and can cause mold to develop. Squeezing the bristles by hand or shaking the brush to displace moisture can cause an uneven distribution of force on the bristles, which can cause damage to the bristles and to the integrity of the mounting interface between the bristles and the brush handle.

### SUMMARY

Embodiments of the inventive concept provide a device for drying a brush including a strap for compressing the bristles of the brush.

According to an exemplary embodiment of the inventive concept, a brush drying device includes a strap having a head portion, a tail portion, and an elongate body portion between the head portion and the tail portion. The head portion includes a slot having a width and a height sized to receive the tail portion there through to form a loop between the head portion and the tail portion with at least the body portion. The further the tail portion is pulled through the slot, the smaller the circumference of the loop becomes, such that, when the loop is placed around bristles of a brush and the tail portion is pulled further through the slot, the decreasing circumference of the loop causes the body portion of the strap to compress the bristles and wring moisture therefrom.

In some embodiments, the body portion has a first width and the head portion has a second width, which is greater than the first width.

In some embodiments, the slot is arranged in the head portion substantially perpendicular to a longitudinal axis of the strap.

In some embodiments, the tail portion has a width that is substantially similar to a width of the slot.

In some embodiments, the strap is formed from a non-moisture-absorbent material.

In some embodiments, the strap is formed from a moisture-absorbent material.

In some embodiments, the strap is formed from a material that facilitates a friction fit between the strap and the slot.

In some embodiments, the strap includes a number of holes in the body portion. The holes can allow moisture to drain and/or evaporate there through.

According to another exemplary embodiment of the inventive concept a brush drying device includes an elongate strap including a proximal end, a distal end, and a medial portion connecting the proximal end to the distal end, an aperture disposed proximate the proximal end, the aperture being sized to receive the distal end of the strap therein to form a loop. The loop, once formed by inserting the distal end of the strap through the aperture, has a circumference that is adjustable based on an amount of the distal end of the strap being pulled away from the aperture, such that, with the loop placed around bristles of a brush, pulling the distal end away from the aperture causes the circumference of the loop to decrease until it compresses the bristles to wring moisture therefrom.

In some embodiments, the medial portion has a first width and the proximal end has a second width, which is greater than the first width.

In some embodiments, the aperture is arranged in the proximal substantially perpendicular to a longitudinal axis of the strap.

In some embodiments, the distal portion has a width that is substantially similar to a width of the aperture.

In some embodiments, the strap is formed from a non-moisture-absorbent material.

In some embodiments, the strap is formed from a moisture-absorbent material.

In some embodiments, the strap is formed from a material that facilitates a friction fit between the strap and the aperture.

In some embodiments, the strap includes a number of holes in the medial portion. The holes can be configured and arranged to allow moisture to drain there through.

According to another exemplary embodiment of the inventive concept a brush drying strap comprises an elongate body portion, a tail portion at a distal end of the elongate body, and a head portion at a proximal end of the elongate body, the head portion including a slot having a width and a height sized to receive the tail portion to form a loop.

In some embodiments, the brush drying strap includes a plurality of holes formed in the elongate body.

In some embodiments, the brush drying strap is a makeup brush drying strap.

In some embodiments, the brush drying strap includes has a length of not more than about 120 mm.

### BRIEF DESCRIPTION OF THE DRAWINGS

The accompanying drawings, which are incorporated in and constitute a part of this specification, illustrate various embodiments and, together with the description, serve to explain the principles of the inventive concepts. In the drawings:

FIG. 1 is a front view of an embodiment a brush drying device in accordance with aspects of the present inventive concepts;

FIG. 2 is a perspective view of the brush drying device of FIG. 1 in accordance with aspects of the present inventive concepts;

FIG. 3 is a perspective view of the brush drying device of FIG. 1 formed into a loop in accordance with aspects of the present inventive concepts;

FIG. 4 is a perspective view of the brush drying device of FIG. 1 beginning to be formed into a loop around the bristles of a brush in accordance with aspects of the present inventive concepts; and

FIG. 5 is a perspective view of the brush drying device of FIG. 1 formed into a loop around the bristles of a brush in accordance with aspects of the present inventive concepts.

### DESCRIPTION OF THE EMBODIMENTS

Reference will now be made in detail to embodiments of the inventive concepts, examples of which are illustrated in the accompanying drawings. Wherever possible, the same reference numbers will be used throughout the drawings to refer to the same or like parts.

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

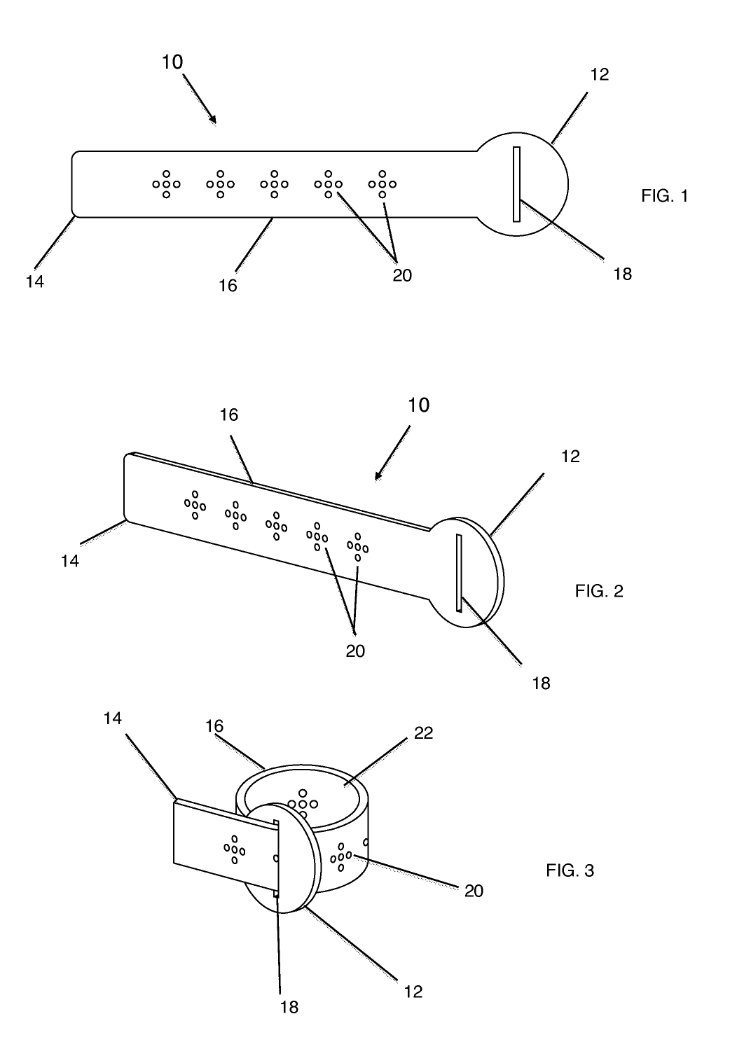

FIG. 1 is a front view of an embodiment of a brush drying device in accordance with aspects of the present inventive concepts and FIG. 2 is a perspective view of the brush drying device of FIG. 1 in accordance with an embodiment of the present inventive concepts. As shown in FIGS. 1 and 2, the brush drying device 10 includes a strap having a head portion 12, a tail portion 14, and a body portion 16 between the head portion 12 and tail portion 14. Head portion 12 includes a slot 18, which, in one embodiment, has a width and height substantially similar to the width and thickness of tail portion 14 and body portion 16. In other embodiments, the slot 18 can have width and height dimensions slightly larger than the width and thickness dimensions of the tail portion 14 and body portion 16.

Device 10 further includes holes 20 along the body portion, which enable moisture to escape there through. As examples, moisture could escape by squeezing out a liquid from a brush or evaporating out a liquid from a brush. The holes could be referred to, in some embodiments, as drying holes. The number and pattern of holes 20 shown in the figures is not essential to the inventive concept and any number of holes in any pattern may be formed in the body portion 16. Alternatively, the device may be constructed without holes 20. As used herein, the term “holes” should not be limited to round openings, other shaped holes or openings are also contemplated by the present invention.

In an embodiment of the inventive concept, the device 10 is formed from a single piece of a flexible, non-moisture-absorbent material such as rubber, silicone, nylon or any other suitable material. In other embodiments, the device may be formed from materials that absorb moisture when used to wring the brush bristles. In further embodiments, head portion 12, tail portion 14 and body portion 16 may be formed from a combination of materials coupled together in a suitable fashion. Even further, the material may have dimensions and/or properties that facilitate a friction fit between the tail and body portions and the slot, to facilitate “locking” the device in place on the brush by not enabling the tail and body portion to freely slide back through the slot once the device is constricted around the bristles.

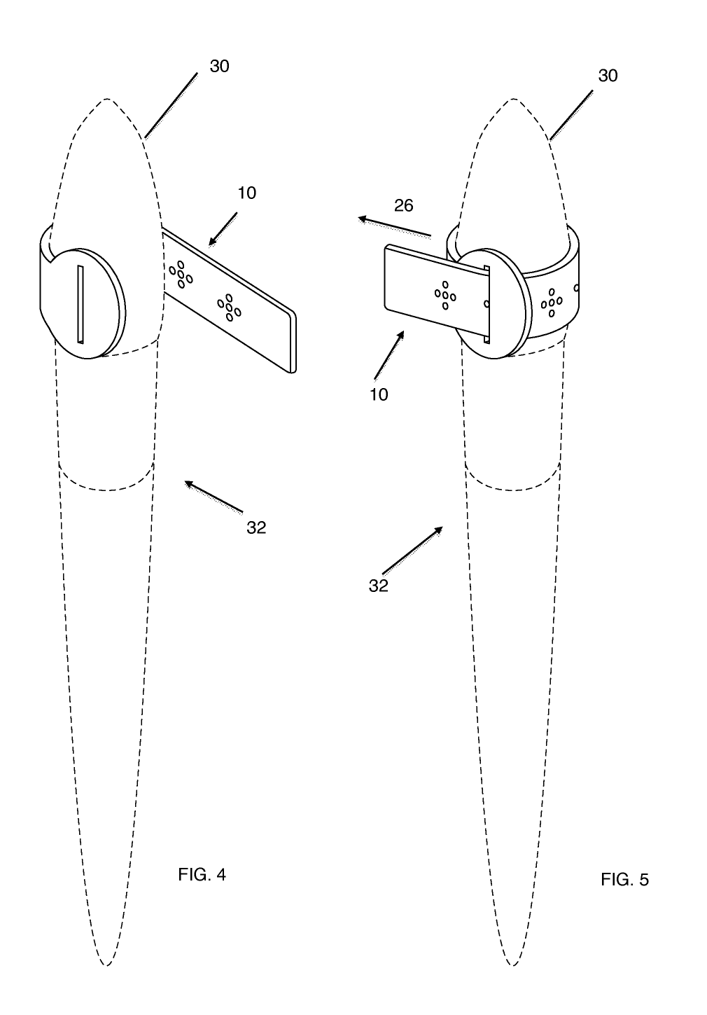

In use, tail portion 14 of device 10 is inserted through slot 18 of head portion 12 to form a loop 22, as shown in FIG. 3. Accordingly, when tail portion 14 is held in one hand and the head portion 12 in the other, and tail portion 14 is pulled away from head portion 12, in the direction of arrow 26, the circumference of loop 22 is decreased. The device can either be placed around the bristles after the loop is formed or, as shown in FIG. 4, the loop may be formed around the bristles 30 of brush 32. In either case, the result is that shown in FIG. 5, with device 10 completely surrounding the bristles 30. In this position, when tail portion 14 is pulled away from head portion 12 in the direction shown by arrow 26, the circumference of loop 22 is decreased, causing device 10 to compress the bristles 30 to wring moisture therefrom. In this embodiment, moisture is enabled to escape from the bristles from the top and bottom openings of the device, as well as through holes 20. With brushes having larger or longer bristle portions, the device may be positioned at multiple locations along the length of the bristle portion to compress the bristles.

Once the moisture has been wrung from the brush, the device may be removed from the bristles by sliding it off of the bristles or by pulling the body and tail portion back through the slot to open the loop. In certain embodiments, the device may be left locked onto wet or dry bristles after compressing them to protect the bristles during storage of the brush. In which case, openings 20 may further enable moisture to evaporate from the brush 30.

Accordingly, embodiments of the inventive concept provide a brush drying device which constricts around the bristles to compress the bristles to wring moisture therefrom while minimizing any uneven distribution of force on the bristles.

While the device 10 is shown as having a relatively rectangular cross-section, with slot 18 being similarly shaped, it will be understood that other shapes or forms may be used. For example, tail portion 14 and body portion 16 may be round, oval, square, lens-shaped etc. in cross-section with a correspondingly-shaped slot 18 or a slot 18 shaped in any manner to enable the device to operate as described above.

In one embodiment, the device 10 is 120 mm long, or thereabouts. The head portion can be about 22.10 mm and the slot 18 can be about 18 mm×1.5 mm. The body portion 16 can be about 97.90 mm×16 mm. And a thickness of the device 10 can be about 2 mm, in some embodiments. In other embodiments, the dimensions can be different. For example, devices with different dimensions, e.g., thicknesses, can be used for brushes with different bristle (or brush head) lengths.

Further, while shown in the figures is a round brush, the device may be used on any shape of brush that is used for any purpose, such as makeup brushes, paint brushes, cleaning brushes, etc. Additionally, the device may be used to dry brushes having any type of bristles, including natural bristles and synthetic bristles.

It is further noted that, since the device 10 is pliable, e.g., made from silicone, when used it can compress the brush head into the correct shape for drying. The ferrule (the part the holds the bristles) can be in any shape and when the bristles are tightly packed, the device 10 conforms to the natural shape of the brush head. Therefore, the ferrule will dictate and maintain the shape of the bristles and the pliability of the device 10 will cause the strap to conform to the already shaped bristles. This would be generally true with brushes having tightly packed bristles, but less so if the bristles were not so tightly packed, as with some fan brushes.

While the present inventive concepts have been particularly shown and described above with reference to exemplary embodiments thereof, it will be understood by those of ordinary skill in the art, that various changes in form and detail can be made without departing from the spirit and scope of the present inventive concepts.

1. A brush drying device comprising:
a strap including a head portion, a tail portion and an elongate body portion between the head portion and the tail portion;
the head portion including a slot having a width and a height sized to receive the tail portion there through to form a loop between the head portion and the tail portion with at least the body portion;
wherein, the further the tail portion is pulled through the slot, the smaller a circumference of the loop becomes, such that, when the loop is placed around bristles of a brush and the tail portion is pulled further through the slot, the decreasing circumference of the loop causes the body portion of the strap to compress the bristles and wring moisture therefrom.

2. The brush drying device of claim 1 wherein the body portion has a first width and the head portion has a second width, which is greater than the first width.

3. The brush drying device of claim 1 wherein the slot is arranged in the head portion substantially perpendicular to a longitudinal axis of the strap.

4. The brush drying device of claim 1 wherein the tail portion has a width that is substantially similar to a width of the slot.

5. The brush drying device of claim 1 wherein the strap is formed from a non-moisture-absorbent material.

6. The brush drying device of claim 1 wherein the strap is formed from a moisture-absorbent material.

7. The brush drying device of claim 1 wherein the strap is formed from a material that facilitates a friction fit between the strap and the slot.

8. The brush drying device of claim 1 wherein the strap includes a number of holes in the body portion for allowing moisture to drain there through.

9. A brush drying device comprising:
an elongate strap including a proximal end, a distal end and a medial portion connecting the proximal end to the distal end; and
an aperture disposed proximate the proximal end, the aperture being sized to receive the distal end of the strap therein to form a loop;
wherein the loop, once formed by inserting the distal end of the strap through the aperture, has a circumference that is adjustable based on an amount of the distal end of the strap being pulled away from the aperture, such that, with the loop placed around bristles of a brush, pulling the distal end away from the aperture causes the circumference of the loop to decrease until it compresses the bristles to wring moisture therefrom.

10. The brush drying device of claim 9 wherein the medial portion has a first width and the proximal portion has a second width, which is greater than the first width.

11. The brush drying device of claim 9 wherein the aperture is arranged in the proximal portion substantially perpendicular to a longitudinal axis of the strap.

12. The brush drying device of claim 9 wherein the distal portion has a width that is substantially similar to a width of the aperture.

13. The brush drying device of claim 9 wherein the strap is formed from a non-moisture-absorbent material.

14. The brush drying device of claim 9 wherein the strap is formed from a moisture-absorbent material.

15. The brush drying device of claim 1 wherein the strap is formed from a material that facilitates a friction fit between the strap and the aperture.

16. The brush drying device of claim 9 wherein the strap includes a number of holes in the medial portion for allowing moisture to drain there through.

17. A brush drying strap comprising:
an elongate body portion;
a tail portion at a distal end of the elongate body; and
a head portion at a proximal end of the elongate body, the head portion including a slot having a width and a height sized to receive the tail portion to form a loop.

18. The brush drying strap of claim 17, further comprising a plurality of holes formed in the elongate body.

19. The brush drying strap of claim 17, wherein the brush drying strap is a makeup brush drying strap.

20. The brush drying strap of claim 17, wherein the brush drying strap has a length of not more than about 120 mm.
